(19) United States
(12) Patent Application Publication
(10) Pub. No.: US 2017/0215355 A1
(43) Pub. Date: Aug. 3, 2017

(54) AUTOMATED DRIP WATERING SYSTEM

(71) Applicant: WATERPULSE, INC., Denver, CO (US)

(72) Inventors: Ronald L. Johnson, San Jose, CA (US); Mark Bigham, Campbell, CA (US); Yugen Lockhart, Palo Alto, CA (US); Idriss Mansouri-Ruiz, San Jose, CA (US)

(21) Appl. No.: 15/489,639

(22) Filed: Apr. 17, 2017

Related U.S. Application Data
(62) Division of application No. 14/716,516, filed on May 19, 2015.

(51) Int. Cl. A01G 27/00

(52) U.S. Cl. CPC A01G 27/003; A01G 27/008; A01G 27/00

(57) ABSTRACT

An automatic drip watering system comprises a waterline and one or more drip watering devices. The one or more drip watering devices each comprise a valve, which is configured to open and drip irrigate an area when weight is applied to the drip watering device. In some embodiments, the one or more watering devices comprise a clip which is configured to accept one or more hanging pots and/or baskets. The clip is pulled down by the weight the hanging pots and/or baskets and the valves open in order to drip irrigate the hanging pots and/or baskets through one or more drip lines.

### FIELD OF THE INVENTION

This invention relates to systems for delivering water to plants and soil. More particularly, this invention relates to drip watering systems for delivering water to a specific area.

### BACKGROUND OF THE INVENTION

Irrigation systems are used in order to artificially apply water to an area where it is needed but not necessarily present. Automated and semi-automated irrigation systems enable areas of agriculture, landscaping and planting to be watered with little effort after the system is configured to deliver a necessary amount of water at a specified time. One key to an effective system is to get as much water and nutrients to the area as possible without over watering. Drip irrigation, rather than casting a wide spray or steady stream of water over a large area, deposits a low-pressure water stream to watering areas. Still though, drip irrigation systems may be inefficient if the systems drip water unnecessarily in areas where no water is needed.

### SUMMARY OF THE INVENTION

An automatic drip watering system comprises a waterline and one or more drip watering devices. The one or more drip watering devices each comprise a valve, which is configured to open and drip irrigate an area when weight is applied to the drip watering device. In some embodiments, the one or more watering devices comprise a clip, hook or loop which is configured to accept one or more hanging pots and/or baskets. The clip is pulled down by the weight of the hanging pots and/or baskets and the valve opens in order to drip irrigate the hanging pots and/or baskets through one or more drip lines.

In one aspect, a drip watering system comprises one or more waterlines and a watering device coupled to the one or more waterlines and comprising one or more valves configured to open and deliver water to an area when weight is added to the watering device. The watering area is able to comprise one or more hanging pots and/or hanging baskets. In some embodiments, the one or more hanging pots are configured to hang on a clip of the watering device. In some embodiments, the system comprises one or more additional watering devices. The watering device and the one or more additional watering devices are able to couple to the same waterline. Alternatively, the watering device and the one or more additional watering devices are able to couple to a different waterline. In some embodiments, the watering device and the one or more additional watering devices independently water a different area. In some embodiments, the one or more waterlines comprise a ¼-inch drip line. In some embodiments, the watering system is grouped into multiple zones. The watering system is able to comprise a timer for starting and stopping the watering system at a predetermined time.

In another aspect, a drip watering device comprises one or more drip lines extending from the watering device and one or more valves configured to open and deliver water to an area through the one or more drip lines when weight is added to the watering device. The watering area is able to comprise one or more hanging pots and/or hanging baskets. In some embodiments, the one or more hanging pots are configured to hang on a clip of the watering device. In some embodiments, the watering device is coupled to a waterline. In some embodiments, the watering device comprises a coupling device for coupling the drip watering device with an additional object. The additional object is able to comprise one of a frame, a post, a hook, a vertical pole, and a horizontal pole.

In a further aspect, a method of drip watering comprises coupling one or more drip watering devices with one or more overhead hangers, coupling the one or more drip watering devices with one or more waterlines and adding weight to the one or more watering devices, wherein one or more valves of the one or more watering devices are configured to open and deliver water to an area when weight is added to the watering device. The watering area is able to comprise one or more hanging pots and/or hanging baskets. In some embodiments, the one or more hanging pots are configured to hang on a clip of the one or more watering devices. In some embodiments, the one or more watering devices are grouped into multiple zones. In some embodiments, a timer is programmed for starting and stopping watering at a predetermined time.

In still a further aspect, a watering valve comprises a valve body and a hanger for hanging an object; the hanger movable between a closed position and an open position, wherein the valve is configured to supply water to the object when the hanger is in the open position. In some embodiments, the object comprises one of a hanging pot and a hanging basket. In some of these embodiments, the one of the hanging pot and the hanging basket is configured to hang on a clip on the watering device. In some embodiments, the watering valve comprises a coupling device for coupling the watering valve with an additional object. In some embodiments, the additional object comprises one of a frame, a post, a hook, a vertical pole, and a horizontal pole.

In another aspect, a drip watering device comprises a body, a clip, one or more drip waterlines and a valve configured to move between an open position for delivering water and a closed position. In some embodiments, the valve is moved to the open position when one of a hanging pot and a hanging basket is hung on the clip. In some embodiments, the valve comprises one or both of an inflow port and an outflow port.

### BRIEF DESCRIPTION OF THE DRAWINGS

FIGS. 1A and 1B illustrate a drip watering system in accordance with some embodiments.

FIG. 2 illustrates a drip watering system in accordance with some embodiments.

FIG. 3 illustrates a method of drip watering in accordance with some embodiments.

FIG. 4 illustrates a drip watering system in accordance with some embodiments.

### DETAILED DESCRIPTION OF THE INVENTION

In the following description, numerous details are set forth for purpose of explanation. However, one of ordinary skill in the art will realize that the invention may be practiced without the use of these specific details or with equivalent alternatives. Thus, the presently claimed invention is not intended to be limited to the embodiments shown but is to be accorded the widest scope consistent with the principles and features described herein. Throughout the description similar components are similarly marked in order to aid comprehension.

Embodiments are directed to a drip irrigation system for irrigating one or more zones and/or areas. The irrigation system comprises a waterline and one or more drip watering devices. The one or more watering devices comprise one or more valves which are configured to open and deliver water to an area through one or more drip lines when weight is added to the watering device. In some embodiments, the one or more watering devices comprise a clip which is configured to accept one or more hanging pots and/or baskets. The clip is pulled down by the weight of the one or more hanging pots and/or baskets and one or more valves are opened to deliver water to the one or more hanging pots and/or baskets through one or more drip lines.

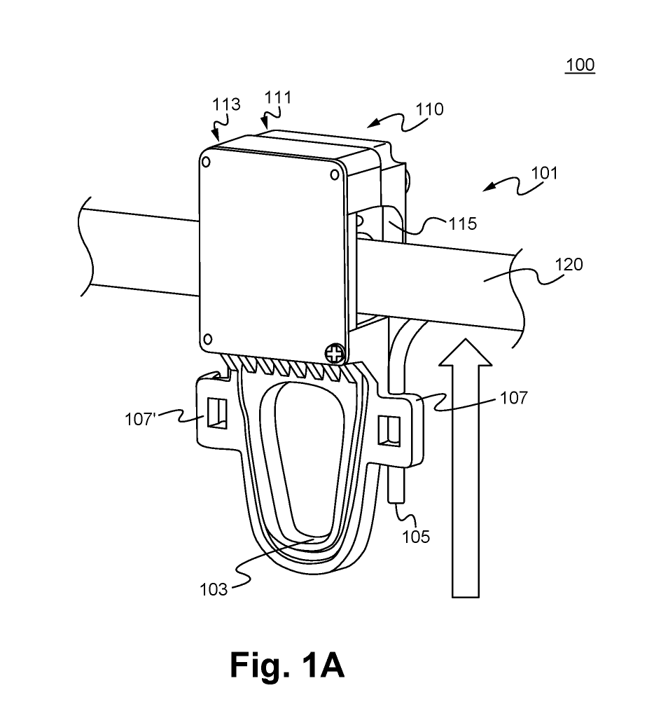

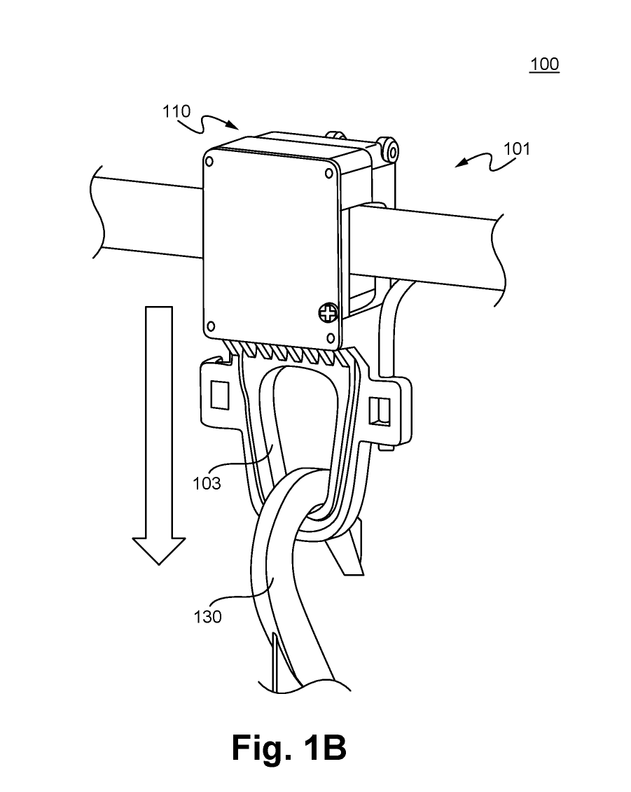

Referring to FIG. 1A, drip watering or drip irrigation system is depicted therein. The drip watering system 100 comprises one or more waterlines (not shown), and a drip watering device 100. The one or more waterlines are able to comprise any appropriately sized waterline capable of delivering a sufficient amount of water to the drip watering device 100. The watering device 100 comprises one or more valves, which are configured to open and deliver water to an area when weight is added to the watering device 100. As shown within FIG. 1A, the one or more valves remain closed until sufficient weight is added to the watering device 100. FIG. 1B illustrates the drip watering device 100 with the one or more valves in an open configuration.

As shown in FIG. 1B, a hanging pot and/or basket 130 has been hung on a clip 103 of the watering device 100. The hanging pot/and or basket 130 adds sufficient weight to the clip 103 in order to pull it to a down position and open the one or more valves and provide drip watering to the hanging pot and/or basket 130. Although a clip 103 and a hanger 130 are shown in FIGS. 1A and 1B a hanging pot and/or basket is able to couple with the drip watering device 100 by any appropriately desired method. As further shown in FIG. 1A, the drip watering device 100 comprises one or more drip waterlines 105 and one or more drip line holders 107 and 107′ for directing the water flow. The drip watering device 100 is able to be used with any appropriately sized hanging plant or hanging arrangement that needs to be watered.

The drip watering device 100 also comprises an upper body 110 comprising a first side 111 and a second side 113 and an aperture 115. The aperture 115 enables the drip watering device 100 to be coupled to an additional object 120. For example, in some embodiments, the drip watering device 100 is coupled to one of a wire, a frame, a post, a hook, a vertical pole, and a horizontal pole. Particularly, the drip watering device 100 is able to couple to any appropriate object that allows the drip watering device 100 to remain a sufficient height off the ground so that the one or more valves are able to open when weight is added to the device 100.

In some embodiments, a plurality of drip watering devices 100 are coupled together in order to drip irrigate multiple hanging pots, baskets, and/or watering areas. In some embodiments, the plurality of watering devices 100 are coupled to the same waterline. Alternatively, or in conjunction, a plurality of different watering devices 100 couple to a plurality of different waterlines. In some embodiments, the plurality of drip watering devices 100 are configured to independently water an area. For example, in some embodiments, only watering devices 100 that comprise a hanging plant and/or basket provide drip irrigation. Particularly, the one or more watering devices 100 are able to be grouped into multiple zones. In some embodiments, a timer is used for starting and stopping the drip watering at predetermined times. Additionally, in some embodiments, a plurality of watering devices 100 are ran according to one or more of an on/off switch, a programmable irrigation timer, one or more environmental sensors, a controller, and an irrigation system operation circuit as described in the co-owned U.S. patent application Ser. No. 13/914,466, and entitled INJECTOR STYLE IRRIGATION SYSTEM, which is hereby incorporated by reference.

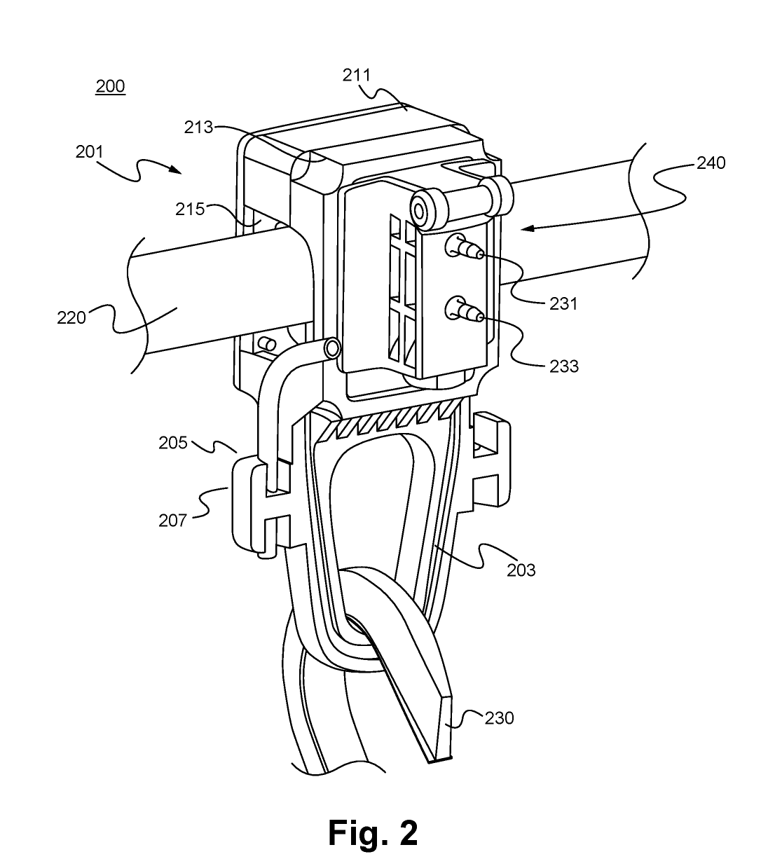

FIG. 2 illustrates a back view of a drip watering device in accordance with some embodiments. The drip watering device 200, is similar to the drip watering device 100, as described above and comprises a body 201, a clip 203, one or more drip waterlines 205, and one or more drip line holders 207 for directing a flow of the drip irrigation. As shown in FIG. 2, the valve 240 is configured to open and deliver water through one or more drip irrigation lines 205 when weight is added to the watering device 200. As described above, in some embodiments, a hanging pot and/or basket 230 adds sufficient weight to the clip 203 in order to pull it to a down position and open the one or more valves and provide drip watering to the hanging pot and/or basket 230. As further described above, the drip watering device 200 also comprises an upper body 210 comprising a first side 211 and a second side 213 and an aperture 215. The aperture 215 enables the drip watering device 200 to couple to an additional object 220. For example, in some embodiments, the drip watering device 200 is coupled to one of a wire, a frame, a post, a hook, a vertical pole, and a horizontal pole. Particularly, the drip watering device 200 is able to couple to any appropriate object that allows the drip watering device to remain a sufficient height off the ground so that the one or more valves are able to open when weight is added to the device 200.

In some embodiments, the valve 201 body is configured to connect to a ¼-inch drip line. However, the valve 201 is able to connect to any appropriately sized drip line. The valve 201 body is configured with one or more ports 231 and 233. In some embodiments, the one or more ports 231 and 233 comprise an inflow port and an outflow port.

In some embodiments, the additional object the drip watering device 200 couples to is a water supply line, hose or tube. In such an embodiment, the water input port 233 is internal and couples directly with the water supply line.

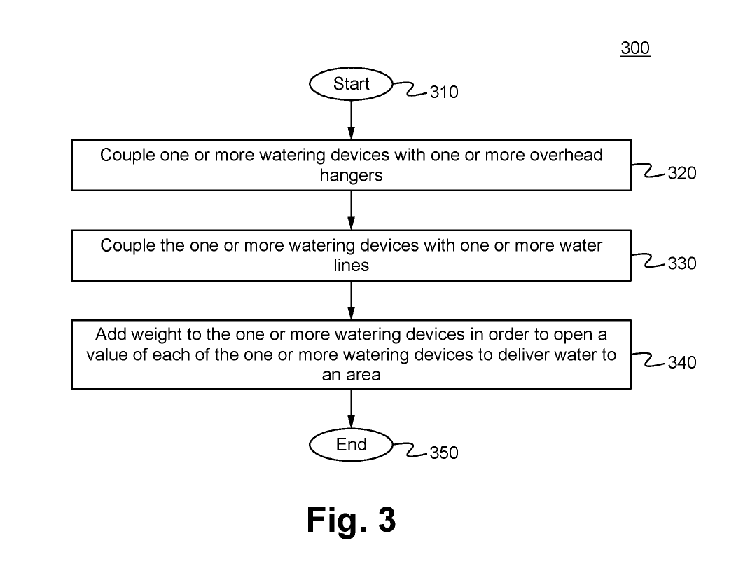

FIG. 3 illustrates a method of drip irrigation in accordance with some embodiments. The method begins in the step 310. In the step 320, one or more drip watering devices are coupled with one or more objects, such as an overhead hanger. As described above, in some embodiments, the drip watering device is coupled to one of a wire, a frame, a post, a hook, a vertical pole, and a horizontal pole. Particularly, the drip watering device is able to couple to any appropriate object that allows the drip watering device to remain a sufficient height off the ground so that the one or more valves are able to open. In the step, 330 the one or more watering devices are coupled with one or more waterlines. As described above, the one or more waterlines are able to comprise any appropriately sized waterline capable of delivering a sufficient amount of water to a drip watering device. Then, in the step 340, weight is added to the one or more watering devices in order to open a valve of the devices and deliver drip irrigation to an area. As described above, in some embodiments, a hanging pot and/or basket is hung on the watering device so that the drip watering device waters the hanging pot and/or basket.

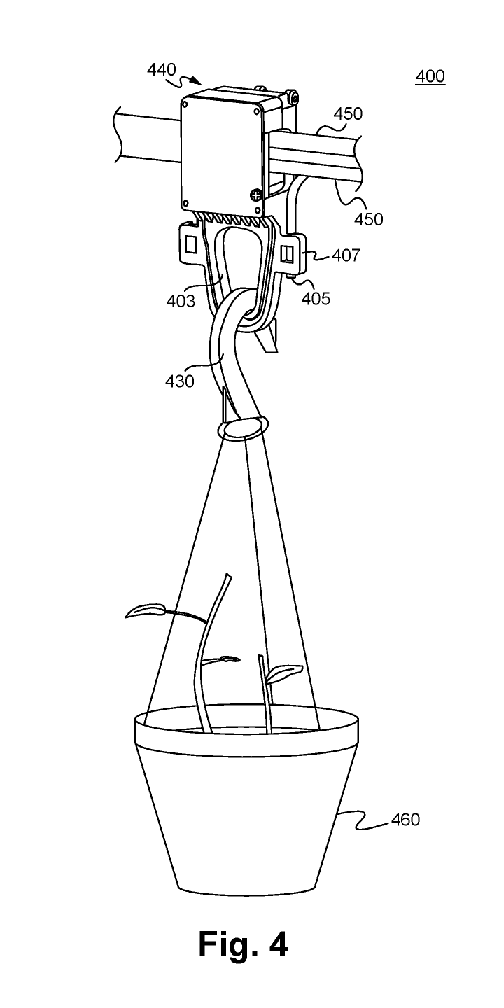

FIG. 4 illustrates a drip watering system in accordance to some embodiments such as described above. The drip watering system 400 comprises one or more waterlines 450, and a drip watering device, such as described above. The one or more waterlines 450 are able to comprise any appropriately sized waterline capable of delivering a sufficient amount of water to the drip watering device. The watering device comprises a body comprising one or more valves 440, which are configured to open and deliver water to an area when weight is added to the system 400, such as described above. The one or more valves 440 remain closed until sufficient weight is added to the watering system 400. As shown in FIG. 4, a hanging pot and/or basket 460 with a hanger 430 has been hung on a clip 403 of the watering system 400. The hanging pot/and or basket 460 adds sufficient weight to the clip 403 in order to pull it to a down position and open the one or more valves and provide drip watering to the hanging pot and/or basket 460. Although a clip 403 and a hanger 430 are shown in FIG. 4, a hanging pot and/or basket is able to couple with the drip watering system 400 by any appropriately desired method. As further shown in FIG. 4, the drip watering system 400 comprises one or more drip waterlines 405 and one or more drip line holders 407 for directing the water flow. The drip watering system 400 is able to be used with any appropriately sized hanging plant or hanging arrangement that needs to be watered.

The drip irrigation system, device and method is configured to provide drip irrigation to one or more hanging pots and/or baskets in order to save time, effort and maintenance while watering a group of plants or area. Particularly, only to those devices which have pots and/or baskets to be watered provide drip irrigation. If there is no weight on the device, indicating an absence of a hanging pot and/or basket, then the watering valve remains closed and no water is provided. Particularly, water is saved by only watering those areas where it is needed. Additionally, because the drip irrigation is automatic it only needs to be set up once in order to correctly water. Accordingly, the irrigation system as described herein has many advantages.

The invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications area able to be made in the embodiment chosen for illustration without departing from the spirit and scope of the invention. Specifically, it will be apparent that the design of the irrigation system is able to be implemented in many different styles and configurations. Further, it will be apparent to one of ordinary skill in the art that the precise structure of the device is able to be substantially varied to accommodate various styles of water sources and watering areas. Consequently, the claims should be broadly construed, consistent with the spirit and scope of the invention, and should not be limited to their exact, literal meaning.

1-21. (canceled)

22. A watering valve comprising:
a. a valve body; and
b. a hanger for hanging an object, wherein the hanger is movable between a closed position and an open position, wherein the valve is configured to supply water to the object when the hanger is in the open position.

23. The watering valve of claim 22, wherein the object comprises one of a hanging pot and a hanging basket.

24. The watering valve of claim 23, wherein the one of the hanging pot and the hanging basket is configured to hang on a clip of the hanger.

25. The watering valve of claim 22, comprising a coupling device for coupling the watering valve with an additional object.

26. The watering valve of claim 25, wherein the additional object comprises one of a frame, a post, a hook, a vertical pole, and a horizontal pole.

27-29. (canceled)

30. The watering valve of claim 22, wherein the valve body is configured for coupling to a water line.

31. A watering valve comprising:
a. a valve body; and
b. a hanger for hanging an object, wherein the hanger is movable from a closed position to an open position when the object is hung on the hanger, wherein the valve is configured to supply water to the object only when the hanger is in the open position.

32. The watering valve of claim 31, wherein the object comprises one of a hanging pot and a hanging basket.

33. The watering valve of claim 32, wherein the one of the hanging pot and the hanging basket is configured to hang on a clip of the hanger.

34. The watering valve of claim 31, comprising a coupling device for coupling the watering valve with an additional object.

35. The watering valve of claim 34, wherein the additional object comprises one of a frame, a post, a hook, a vertical pole, and a horizontal pole.

36. The watering valve of claim 31, wherein the valve body is configured for coupling to a water line.

37. A watering valve comprising:
a. a valve body configured for coupling to a water line; and
b. a hanger for hanging an object, wherein the hanger is movable from a closed position to an open position when the object is hung on the hanger, wherein the valve is configured to supply water to the object from the water line only when the hanger is in the open position.

38. The watering valve of claim 37, wherein the object comprises one of a hanging pot and a hanging basket.

39. The watering valve of claim 38, wherein the one of the hanging pot and the hanging basket is configured to hang on a clip of the hanger.

40. The watering valve of claim 37, comprising a coupling device for coupling the watering valve with an additional object.

41. The watering valve of claim 40, wherein the additional object comprises one of a frame, a post, a hook, a vertical pole, and a horizontal pole.
